(19) United States
(12) Patent Application Publication
(10) Pub. No.: US 2023/0417409 A1
(43) Pub. Date: Dec. 28, 2023

(54) DECORATIVE-FLAME BURNER

(71) Applicant: Warming Trends, LLC, Englewood, CO (US)

(72) Inventors: Timothy Flaherty, Greenwood Village, CO (US); Kevin O'Connor, Parker, CO (US); Bryan Small, Littleton, CO (US); Jeremiah Bulla, Denver, CO (US)

(21) Appl. No.: 18/253,060

(22) PCT Filed: Nov. 23, 2021
(86) PCT No.: PCT/US2021/060434

§ 371 Date: May 16, 2023

Related U.S. Application Data
(60) Provisional application No. 63/117,481, filed on Nov. 24, 2020.

(51) Int. Cl. F23D 14/04; F23K 5/00

(52) U.S. Cl. CPC F23D 14/045; F23K 5/007

(57) ABSTRACT

A burner includes an inlet coupling, a plurality of nipples, and jets. The plurality of nipples are fluidly connected to the inlet coupling. The jets are supported by and protrude upwardly from the nipples. At least one of the jets including an oxygen hole. The inlet coupling includes an inlet hole, an outlet hole, and a passageway extending from the inlet hole to the outlet hole. The passageway of the inlet coupling includes a crest between the inlet hole and the outlet hole. The passageway extends upwardly from the inlet hole to the crest and the passageway extends downwardly from the crest to the outlet hole. The crest being above at least one oxygen hole of the jets.

### CROSS-REFERENCE TO RELATED APPLICATIONS

The subject patent application claims priority to and all the benefits of Patent Cooperation Treaty Application No. PCT/US2021/0060434 which was filed on Nov. 23, 2021 and claims priority to U.S. Provisional Patent Application No. 63/117,481 which was filed on Nov. 24, 2020, both of which are herein incorporated by reference in their entireties.

### BACKGROUND

A decorative-flame burner generates a flame that is decorative for the purpose of viewing. As examples, the burner may be used in a fire pit, fireplace, flame and water feature, etc. During operation of the burner, the flame is visible and the burner may be exposed or may be covered, entirely or partly, by an aggregate substrate (e.g., rock, stone, glass, etc.), faux logs (e.g., ceramic, steel, etc.), water, etc.

Decorative-flame burners may be exposed to water in some uses. For example, the decorative-flame burner may be used outdoors and may be exposed to environmental precipitation such as rain and snow. As another example, the decorative-flame burner may be used near water features, e.g., pools, fountains, etc., that may result in inadvertent exposure to water.

### BRIEF DESCRIPTION OF THE DRAWINGS

FIG. 1 is a perspective view of one example of a decorative-flame burner.

FIG. 2 is a side view of the decorative-flame burner.

FIG. 3 is a perspective view of an example of an inlet coupling of the decorative-flame burner.

FIG. 4 is a cross-section of the inlet coupling along line 4 in FIG. 3.

FIG. 5 is a cross-section of the inlet coupling along line 5 in FIG. 3.

FIG. 6 is a side view of the inlet coupling including a passageway shown in hidden lines.

FIG. 7 is a top view of the inlet coupling including the passageway shown in hidden lines.

FIG. 8 is a bottom view of the inlet coupling including the passageway shown in hidden lines.

FIG. 9 is a cross-section of another example of the inlet coupling including a drain plug.

FIG. 10 is a bottom view of the inlet coupling of FIG. 9.

### DETAILED DESCRIPTION

### Introduction

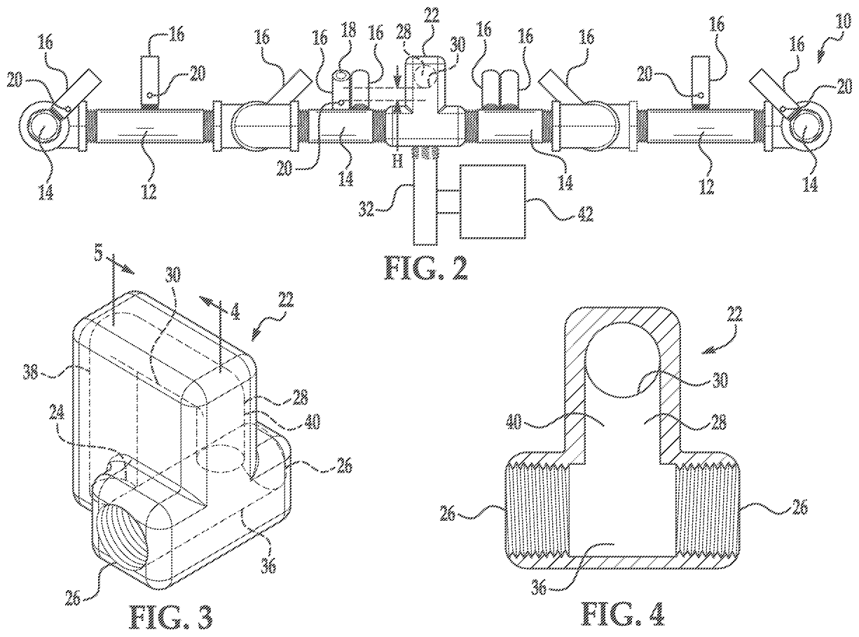

With reference to the Figures, wherein like numerals indicate like parts throughout the several views, a burner 10 includes at least one nipple 12, 14 and at least one jet 16 supported by and protruding upwardly from the nipple 12, 14. The jet 16 include an opening. Specifically, at least one of the jets 16 includes a fuel-combustion outlet 18 and an oxygen hole 20. The burner 10 includes an inlet coupling 22 that supplies fuel to the nipple 12, 14 and the jet 16. The inlet coupling 22 includes an inlet hole 24, an outlet hole 26, and a passageway 28 extending from the inlet hole 24 to the outlet hole 26. The passageway 28 includes a crest 30 between the inlet hole 24 and the outlet hole 26. The passageway 28 may extend upwardly from the inlet hole 24 to the crest 30 and the passageway 28 extends downwardly from the crest 30 to the outlet hole 26. The crest 30 is above the outlet hole 26. For example, the crest 30 is above at least one opening of at least one of the jets 16, for example, at least one fuel-combustion outlet 18 and/or at least one oxygen hole 20 (an example of which is identified with reference H in FIG. 2).

In the event the burner 10 is exposed to water, e.g., in the form of environmental precipitation, from a water feature, etc., and water enters the jet 16, the water may accumulate in the nipple 12, 14 and jet 16. In such an event, the water does not overcome the crest 30 to reach the inlet hole 24 because the crest 30 is above at least one opening of the jet 16. In other words, the water lacks the hydraulic pressure to reach the height of the crest 30 because the water first drains from the burner 10 through the opening(s), e.g., the fuel-combustion outlet 18 and/or the oxygen hole 20, lower than the crest 30. These relatively lower opening(s) prevent sufficient head to rise above the crest 30. This prevents the water from reaching the inlet hole 24 of the inlet coupling 22, which would then cause the water to drain into an inlet fuel line 32 connected to the inlet hole 24 of the inlet coupling 22.

### Burner

The burner 10 generates a flame that is decorative for the purpose of viewing. In other words, the burner 10 is a decorative-flame burner. As examples, the burner 10 may be used in a fire pit, fireplace, water feature, etc. In use, the flame is visible and the burner 10 may be exposed or may be covered, entirely or partly, by an aggregate substrate (e.g., rock, stone, glass, etc.), faux logs (e.g., ceramic, steel, etc.), water, etc.

The burner 10 is configured to generate a decorative flame that is at least partly yellow and/or orange. As an example, the burner 10 may be configured to generate a flame that has a small blue portion at the jet with the remainder of the flame being yellow and/or orange to the tip of the flame. In such an example, the blue portion may be of a minimal size such that the blue portion is not viewable, e.g., may be covered by substrate. As another example, the burner 10 may be configured to generate a flame that is all yellow and/or orange, i.e., from the point of combustion at the jets 16 to a tip of the flame distal to the jets 16. Specifically, the burner 10 is configured to discharge the fuel from the jets 16 at an air-to-fuel ratio to generate a flame that is yellow and/or orange. The burner 10 is configured to burn a fuel-rich combustion mixture at an air-to-fuel ratio to generate the yellow color. Specifically, the fuel-rich combustion mixture generates the yellow and/or orange flame in contrast with a fuel-lean combustion mixture that generates a blue flame. As an example, a blue flame may be used in applications in which the flame is used solely for heat generation, e.g., for heating, cooking, etc., without concern for decorative appearance. The jet 16 may generate a Venturi effect to mix air with the fuel to feed an air-to-fuel ratio at the point of combustion to generate a flame that is yellow and/or orange. For natural gas and propane, for example, the burner 10 may be configured to burn at approximately 1000-1200° C. to generate the yellow and/or orange color of the flame.

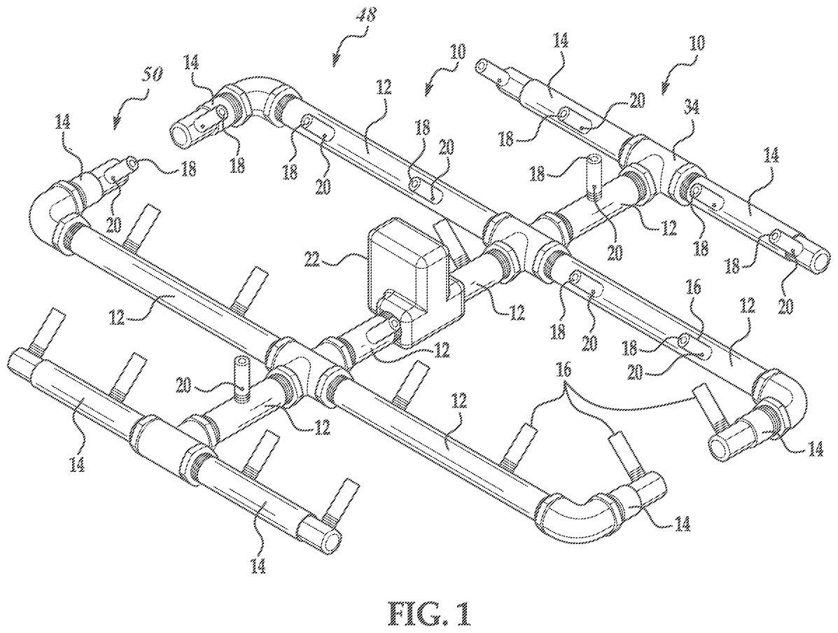

The burner 10 is configured to generate a tall, dancing flame. This is generated, in part, by the flow rate of fuel to the jet 16 and the Venturi effect generated by the jet 16 to discharge the air-fuel combination at a high velocity. In addition, each jet 16 generates a flame and each flame from each jet 16 dances. In other words, the jets 16 are configured to discharge the air/fuel mixture such that the flame fluctuates in width and height during a stable fuel supply rate at the inlet coupling 22. The flames from the individual jets 16 intermingle and/or combine. In some examples, the flames combine together by swirling based on the aim of the jets 16 relative to each other. The flames from all of the jets 16, in combination, dance. The burner 10 described herein may operate, for example, at 60,000-450,000 BTU. For example, the burner 10 in FIG. 1 may operate at 220,000 BTU. The jets 16 shown in FIG. 1, for example, may each operate at 10,000 BTU.

The footprint of the burner 10 provides, at least in part, the generation of the tall, dancing flame. Specifically, the relative location of the jets 16, at least in part, generates the tall, dancing flame. As an example, the elongation of the nipples 12, 14 along straight axes, respectively, that are transverse to each other provides the footprint to locate the jets 16 for generation of the tall, dancing flame. The axes of adjacent nipples 12, 14 may be perpendicular to each other. For example, for intermediate nipples 12 and end nipples 14 as described below, the intermediate nipples 12 may be perpendicular to the axes of adjacent end nipples 14 to create the footprint of the burner 10 that provides, at least in part, the generation of the tall, dancing flame.

The burner 10 may be brass. Specifically, the intermediate nipples 12, the end nipples 14, the jets 16, fittings 34, and the inlet coupling 22 may be brass. The brass is corrosion resistant, sustainable, and rust-proof.

### Nipples

As set forth above, the burner 10 includes at least one nipple 12, 14. In the example shown in the Figures, the burner 10 includes a plurality of nipples 12, 14. Specifically, the burner 10 includes end nipples 14 and may include intermediate nipples 12. The end nipples 14, intermediate nipples 12 (in examples including end nipples 14), and jets 16 in combination define a gas passageway to deliver fuel from the inlet coupling 22 to the jets 16. Specifically, the end nipples 14, the intermediate nipples 12, and the jets 16 each have a bore and the bores define the gas passageway from the inlet coupling 22 to fuel-combustion outlets 18 of the jets 16. The jets 16 release the fuel to the atmosphere where the fuel is combusted as a decorative flame. The burner 10, including the end nipples 14, intermediate nipples 12 (in examples including intermediate nipples 12), and jets 16, may be designed to deliver and burn any suitable type of gaseous fuel, including natural gas and propane.

Each intermediate nipple 12 is elongated along a longitudinal axis. In other words, the longest dimension of the intermediate nipple 12 is along the longitudinal axis of the intermediate nipple 12. The intermediate nipples 12 may be elongated in a common plane. In use, i.e., during operation of the burner 10, the common plane may be horizontal.

Each intermediate nipple 12 includes two ends and a side extending from one end to the other end. The ends and the side of the intermediate nipple 12 are unitary, i.e., a single, continuous piece of material with no seams, joints, fasteners, welds, or adhesives holding it together. Each intermediate nipple 12 may be formed as a unitary component, for example, by machining from a unitary blank, molding, forging, casting, etc. Non-unitary components, in contrast, are formed separately and subsequently assembled, e.g., by threaded engagement, welding, etc. In the example shown in the Figures, each intermediate nipple 12 is formed by machining a brass bar, e.g., to include a bore and the other features of the intermediate nipple 12 described herein.

The ends of the intermediate nipples 12 are spaced from each other along the longitudinal axis of the intermediate nipple 12. Each intermediate nipple 12 may be straight from one end to the other end of the intermediate nipple 12. Specifically, the longitudinal axis of the intermediate nipple 12 may be straight.

Both end of the intermediate nipple 12 are threaded, i.e., include threads (not numbered). The threads on the ends may be of the same type. For example, the threads on the ends may be ¼-18 NPT threads. The threads on the ends match the threads on the outlet hole 26 of inlet coupling 22 and threads on fittings 34 (as described below).

The bore of the intermediate nipple 12 extends through both ends of the intermediate nipple 12. In other words, both ends of the intermediate nipple 12 are open. When the burner 10 is assembled, the bore creates the gas passageway extending through both ends of the intermediate nipple 12.

Each intermediate nipple 12 may include a hole, e.g., a threaded hole, extending through the side of the intermediate nipple 12 to the bore of the intermediate nipple 12 for receiving one of the jets 16. The hole may include threads that match threads of a threaded portion of the jet 16. For example, the threads may be 1/16-27 NPT threads.

A corresponding number of the intermediate nipples 12 (i.e., one for each outlet hole 26 of the inlet coupling 22) are directly connected to outlet holes 26 of the inlet coupling 22, i.e., with the lack of any intermediate component therebetween. In such an example, “directly connected” includes examples in which thread sealant is disposed between the intermediate nipples 12 and the inlet coupling 22. The inlet coupling 22 may be a hub that feeds one or more intermediate nipples 12. In examples in which multiple intermediate nipples 12 are connected to the inlet coupling 22, the intermediate nipples 12 extend in different directions. In an example including the two intermediate nipples 12 connected to the inlet coupling 22, the intermediate nipples 12 may be coaxial, i.e., elongated along a common axis, as shown in the example in FIG. 1. The intermediate nipples 12 are supported by the inlet coupling 22.

Each end nipple 14 includes an end that is threaded and an end that is closed. Each end nipple 14 includes a wall extending from one end to the other end of the end nipple 14 and defines a bore extending through the ends. The ends of the end nipple 14 and the wall of the end nipple 14 are unitary, i.e., a single, continuous piece of material with no seams, joints, fasteners, welds, or adhesives holding it together. Each end nipple 14 may be formed as a unitary component, for example, by machining from a unitary blank, molding, forging, casting, etc. In the example shown in the Figures, each end nipple 14 is formed by machining a brass bar, e.g., to include the gas passageway and the other features of the end nipple 14 described herein.

Each end nipple 14 is elongated along a longitudinal axis. In other words, the longest dimension of the end nipple 14 is along the longitudinal axis of the end nipple 14. The end nipples 14 may be elongated in a common plane. Specifically, the end nipples 14 and the intermediate nipples 12 may be elongated in a common plane. As describe above, during operation of the burner 10, the common plane may be horizontal.

Each end nipple 14 is connected to one fitting 34. For example, each end nipple 14 is threadedly engaged with one respective fitting 34. Each end nipple 14 is supported by the respective fitting 34. Specifically, each end nipple 14 is cantilevered from the respective fitting 34.

The ends of the end nipple 14 are spaced from each other along the longitudinal axis of the end nipple 14. Each end nipple 14 may be straight from one end to the other end. The end nipple 14 may be cantilevered from the fitting 34. Specifically, the second end is supported only by the connection of the first end to the fitting 34.

One end of the end nipple 14 may be threaded, i.e., includes threads. The threads threadedly engage one respective fitting 34. That is, the threads of each end nipple 14 engage one respective threaded hole of one respective fitting 34. The threads of the end of the end nipple 14 match the threads of the threaded holes of the fittings 34. For example, the threads may be ¼-18 NPT threads.

The bore of the end nipple 14 is elongated along the longitudinal axis. The bore extends through one end of the end nipple 14 to the other end of the end nipple 14. One end of the end nipple 14 is open and the other end of the end nipple 14 is closed. In other words, the bore extends through one end of the end nipple 14 and is plugged at the other end of the end nipple 14. The bore of the end nipple 14 is elongated along the longitudinal axis of the end nipple 14.

Each end nipple 14 includes a hole, e.g., a threaded hole, extending through the wall of the end nipple 14 to the bore for receiving one of the jets 16. The hole may include threads that match threads of a threaded portion of the jet. For example, the threads may be 1/16-27 NPT threads.

The intermediate nipples 12 and/or the end nipples 14 may include flats. As an example, the end nipples 14 in FIG. 1 are shown to include the flats. Similarly, the intermediate nipples 12 may include flats. The flats can be rotated to threadedly engage the nipples 12, 14 with adjacent components. The flats may be engaged by a tool to transfer torque from the tool to the nipple 12, 14 for engaging the threads with adjacent components.

### Fittings

The burner 10 includes a plurality of the fittings 34. The burner 10 includes a same number of fittings 34 as intermediate nipples 12. The intermediate nipples 12 and the end nipples 14 are connected to each other via the fittings 34. In other words, the gas passageway extends through the fittings 34.

The fittings 34 are directly connected to the respective end nipples 14 and intermediate nipples 12, i.e., with the lack of any intermediate component therebetween. In such an example, “directly connected” includes examples in which thread sealant is dispose between the fitting 34 and the respective end nipple 14 and intermediate nipple 12.

The fittings 34 may have any suitable shape. For example, the fittings 34 may be T-shaped, elbow-shaped, cross-shaped, etc. Each fitting 34 includes at least two threaded holes (not numbered). The fittings 34 may be a standard fitting 34 as known in industry. The fittings 34 may be the same size as the inlet coupling 22. For example, the fitting 34 may be ¼-18 National NPT sized fitting 34 available from any standard supplier. In such an example, the threaded holes of the fitting 34 have ¼-18 NPT threads and a standard corresponding sized and shaped body. The fittings 34 may be brass, as set forth above. Additionally, one or more fittings 34 may include a threaded opening (not shown) for receiving a jet 16.

### Inlet Coupling

With reference to FIG. 2, the inlet coupling 22 is connected to a fuel supply line 32 to deliver fuel to the burner 10. Specifically, the inlet coupling 22 includes an inlet hole 24 for connection to the fuel supply line 32. The fuel supply line 32 may include, for example, a threaded pipe and the inlet hole 24 may be threaded to threadedly engage the threaded pipe of the fuel supply line 32. The inlet coupling 22 may be formed, for example, by casting, additive manufacturing, etc.

As shown in the example in the Figures, the inlet coupling 22 may be a unitary block, i.e., a single, continuous block of material with no seams, joints, fasteners, welds, or adhesives holding it together. The inlet hole 24, the outlet holes 26, and the passageway 28 extend through the unitary block. In other words, the inlet hole 24, the outlet holes 26, and the passageway 28 are formed in the block as opposed to being formed of piping, tubing, etc. The inlet hole 24, the outlet holes 26, and the passageway 28 may be formed in the block, for example, by casting, molding, machining, combinations thereof, etc. As an example, the inlet coupling 22 may be a unitary block of brass. The inlet coupling 22 may have a cuboid-shaped portion in which the passageway 28 extends. In the example shown in the Figures, the inlet coupling has a main portion that is cuboid-shaped with the passage 28 extending therethrough and two other cuboid-shaped portions with the outlet holes 26 in the two other cuboid-shaped portions.

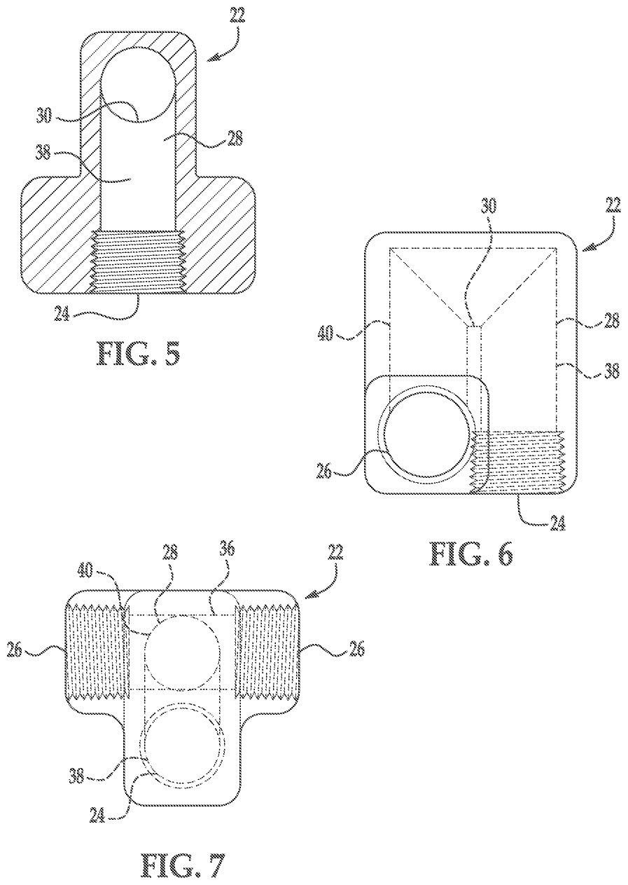

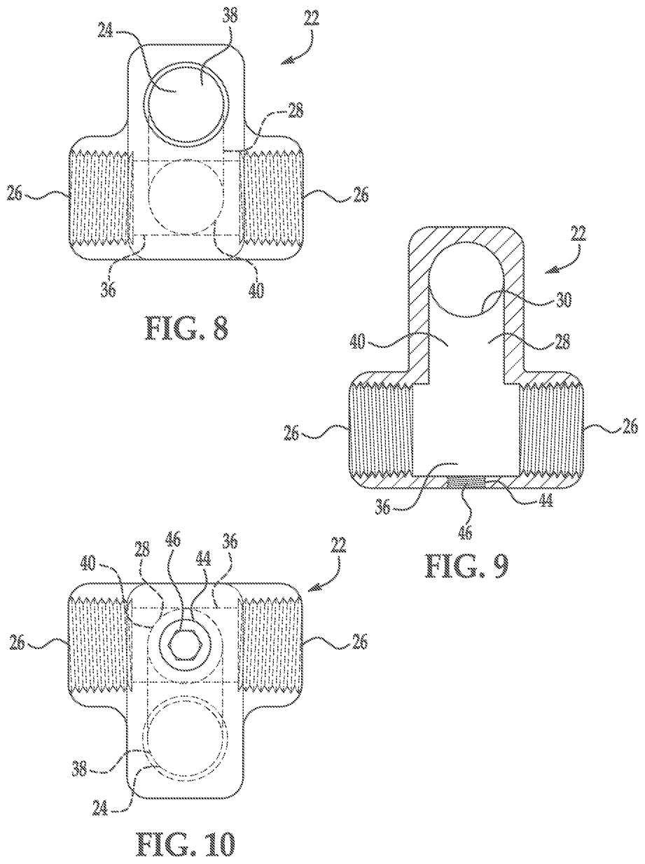

With reference to FIGS. 2-8, the inlet coupling 22 includes at least one outlet hole 26 to deliver fuel to the gas passageway in the nipples 12, 14 and the jets 16. As an example, as shown in the Figures, the inlet coupling 22 includes two outlet holes 26 (namely, a first outlet hole and a second outlet hole). As other examples, the inlet coupling 22 may include any suitable number of outlet holes 26, i.e., one or more.

The nipple is directly connected to the outlet hole of the inlet coupling 22. For example, in the examples shown in FIG. 1, intermediate nipples 12 are directly connected to the outlet holes 26, i.e., with the lack of any intermediate component therebetween. The outlet holes 26 of the inlet coupling 22 may be threaded. For example, the intermediate nipple 12 includes a thread threadedly engaged with the outlet holes 26. In such an example, “directly connected” includes examples in which thread sealant is disposed between the intermediate nipple 12 and the inlet coupling 22. In examples in which the outlet holes 26 of the inlet coupling 22 are threaded, the threads may be, for example, ¼-18 National Pipe Thread Taper (NPT).

The nipple is supported by the inlet coupling 22. For example, in examples including the intermediate nipples 12 and the end nipples 14, nipples 12, 14 are supported by the inlet coupling 22. In that example, the intermediate nipples 12 are directly connected to the outlet holes 12 and the end nipples 14 are supported on the inlet coupling 22 by the respective intermediate nipple 12. The intermediate nipples 12 are supported by the inlet coupling 22. Specifically, a branch 48, 50 of intermediate nipples 12, end nipples 14, fittings 34, and jets 16 is supported by the inlet coupling 22, i.e., the weight of the branch 48, 50 is borne by the inlet coupling 22. The branch 48, 50 may be cantilevered from the inlet coupling 22, i.e., with all weight of the branch 48, 50 supported at the inlet coupling 22. The examples in FIG. 1 include two branches 48, 50, i.e., one branch 48, 50 supported by each outlet hole 26 of the inlet coupling 22. The inlet coupling 22 may include a threaded hole (not shown) that threadedly receives one of the jets 16.

With reference to FIGS. 3-8, the passageway 28 of the inlet coupling 22 extends from the inlet hole 24 to the outlet hole 26. Specifically, the passageway 28 is continuous from the inlet hole 24 to the outlet hole 26 to pass fuel from the inlet hole 24 to the outlet hole 26. In examples that include more than one outlet hole 26, the passageway 28 splits to the outlet holes 26, e.g., as shown in FIGS. 3 and 4.

The crest 30 of the passageway 28 is between the inlet hole 24 and the outlet hole 26. As described further below, the crest 30 blocks flow of water from the outlet hole 26 to the inlet hole 24. Specifically, in the event water enters the nipples 12, 14 through the jets 16, the crest 30 is a barrier to water with insufficient head to rise above the crest 30.

In use, as shown in FIGS. 1 and 2, the crest 30 is above the outlet hole 26. In other words, the crest 30 is at a higher vertical elevation than the outlet hole 26. Accordingly, any water at the outlet hole 26 can only rise toward the crest 30 by rising against gravity. In addition, the crest 30 may be above the inlet hole 24, as shown in the example in the Figures. As another example the crest 30 may be at the same vertical level as the crest 30. In examples including more than one outlet hole 26, the crest 30 is above each of the outlet holes 26.

The passageway 28 extends downwardly from the crest 30 toward the outlet hole 26. Specifically, the passageway 28 has a vertical component from the crest 30 toward the outlet hole 26. In the example, shown in the Figures, the passageway 28 is generally vertical from the crest 30 to the outlet hole 26. In examples including more than one outlet hole 26, the passageway 28 splits to the outlet holes 26. In the example shown in the Figures, the passageway 28 includes a split 36 at the outlet holes 26 and the passageway 28 extends from the crest 30 to the split 36, e.g., generally vertically, and the split 36 extends to the outlet holes 26.

In the example shown in the Figures, the passageway 28 extends upwardly from the inlet hole 24 to the crest 30. Specifically, in the example shown in the Figures, the passageway 28 includes a first leg 38, a second leg 40, and the crest 30 between the first leg 38 and the second leg 40. The first leg 38 is between the inlet hole 24 and the crest 30 and the second leg 40 is between the outlet hole 26 and the crest 30. In the example shown in the Figures, the first leg 38 extends from the inlet hole 24 to the crest 30. In the example shown in the Figures, the second leg 40 extends from the crest 30 to the split. In that example, the split extends from the second leg 40 to the outlet holes 26.

In use, as shown in FIGS. 1 and 2, the first leg 38 and the second leg 40 each extend in a direction that has a vertical component. In the example in FIGS. 1 and 2, the first leg 38 and the second leg 40 are both generally vertical. The crest 30 includes a horizontal component from the first leg 38 to the second leg 40. In the example in FIGS. 1 and 2, the crest 30 is generally horizontal. In the example shown in FIGS. 1 and 2, the split is generally horizontal. The first leg 38, the second leg 40, the crest 30, and the split may, for example, have generally the same cross-section.

In use, the crest 30 may be above at least one opening in at least one jet 16. One example is identified with height difference H in FIG. 2. In other words, the crest 30 may be vertically higher than at least one opening in at least one jet 16. As set forth above, in use, the nipples 14, 16 may in the common plane that is horizontal, as shown in the example in FIGS. 1 and 2. The opening of the jet 16 includes the fuel-combustion outlet 18. In examples including oxygen holes 20, the openings of the jet 16 includes the oxygen hole 20. In the example shown in FIG. 2, the crest 30 is above the oxygen hole 20 of several of the jets 16. As another example, the crest 30 may be above the fuel-combustion outlet 18 of at least one of the jets 16.

Since the crest 30 is above the outlet hole 26, any water that may enter the burner 10 through the jets 16 may accumulate in the nipples and jets 16 and potentially the portion of the passageway 28 between the outlet opening and the crest 30, e.g., the second leg 40. In the example shown in the Figures, since the crest 30 is above at least one opening of at least one jet 16, e.g., fuel-combustion outlet 18 and/or oxygen hole 20, water in the nipples does not overcome the crest 30 to reach the inlet hole 24. Specifically, the water lacks the hydraulic pressure to reach the height of the crest 30 because the water first drains from the burner 10 through the opening(s), e.g., the fuel-combustion outlet 18(s) and/or the oxygen hole 20(s), lower than the crest 30. These relatively lower opening(s) prevent sufficient head to rise above the crest 30. This prevents the water from reaching the inlet hole 24 of the inlet coupling 22, which would then cause the water to drain into the inlet fuel line 32 connected to the inlet hole 24 of the inlet coupling 22.

With reference to FIG. 2, the burner 10 may include an ignition box 42 on the inlet fuel line 32. In such an example, the ignition box 42 includes electronics for controlling the supply of fuel to the inlet coupling 22 and ignition of the fuel. The crest 30, as described above, prevents water intrusion to the ignition box 42.

With reference to FIGS. 9 and 10, the inlet coupling 22 may include a drain opening 44 and a drain plug 46 removably engaged with the drain opening 44. The drain plug 46 is shown as an example in FIGS. 9 and 10. The drain plug 46 is releasably connected to the rest of the inlet coupling 22 at the drain opening 44. As an example, the drain plug 46 and the drain opening 44 may be threadedly engaged with each other. In the event that water accumulates in the nipples and the inlet coupling 22 (e.g., in the second leg 40), the water may be released by removal of the drain plug 46 from the drain opening 44. The drain plug 46 is engaged with the drain opening 44 during use of the burner 10, e.g., during fuel supply and burn. When engaged with the drain opening 44, the drain plug 46 seals the drain opening 44 to prevent fluid flow through the drain opening 44. As an example, the drain plug 46 may be removed from the drain opening 44 during times in which the burner 10 is not used, e.g., during off-season times. The inlet coupling 10 shown in FIGS. 9 and 10 may be identical to the inlet coupling shown in FIGS. 1-8 with the exception of the drain opening 44 and the drain plug 46. As another example, the drain opening 44 may remain open, i.e., unplugged by a drain plug, at all times, including during use of the burner 10. Accordingly, any water accumulated in the inlet coupling 22 may drain through the drain opening 44 at all times. In such an example, the drain opening 44 is sized to allow water drainage and minimize gas loss through the drain opening 44. The nipples 12 that connect to the inlet coupling 22 may extend from the inlet coupling 22 at an upward angle, e.g., 1-2 degrees above horizontal, to encourage water flow to the drain opening 44. In such an example, the outlet hole 26 may be at an angle and/or the nipple 12 extending from the outlet hole 26 may be angled upwardly relative to the outlet hole 26.

### Jets

As set forth above, the burner includes at least one jet 16. In the example shown in the Figures, the burner 10 includes a plurality of jets 16. The burner 10 may include any suitable number of jets 16 connected to the end nipples 14 and the intermediate nipples 12. Each end nipple 14 supports at least one jet 16. In the example shown in FIG. 1, each end nipple 14 and each intermediate nipple 12 support one jet 16. As other examples, each end nipple 14 may support any suitable number of jets 16, i.e., one or more, and each intermediate nipple 12 may support zero or any suitable number of jets 16. As another example, jets 16 may be supported by the fittings 34 and/or the inlet coupling 22.

Each jet 16 is connected to the respective end nipple 14, intermediate nipple 12, fitting 34, or inlet coupling 22. For example, each jet 16 is threadedly engaged with the respective end nipple 14, intermediate nipple 12, or fitting 34. In other words, each jet 16 is formed separately from and subsequently attached to the respective end nipple 14, intermediate nipple 12, or fitting 34. The jets 16 are in communication with the bores of the end nipples 14 and the intermediate nipples 12.

The jet 16 protrudes outwardly from the respective end nipple 14, intermediate nipple 12, or fitting 34. Each jet 16 may be elongated along a longitudinal axis. In other words, the longest dimension of the jet 16 is along the longitudinal axis of the jet 16. The jets 16 may be aimed in any suitable direction to generate the tall, dancing flame. The longitudinal axis of the jet 16 extends upwardly from the common plane at a non-right angle. Accordingly, the flame from all jets 16 combine into a single flame that is generally conical.

Each jet 16 has at least one free opening that is open to the environment. Specifically, each jet 16 includes a fuel-combustion outlet 18. In addition, one or more of the jets 16 may include an oxygen hole 20.

Each jet 16 includes a proximate end and the fuel-combustion outlet 18 is spaced from the proximate end along the longitudinal axis of the jet 16. Each jet 16 includes a wall extending from the proximate end to the fuel-combustion outlet 18. The bore of the jet 16 extends through the proximate end and the fuel-combustion outlet 18.

The proximate end of the jet 16 is connected to the end nipple 14, intermediate nipple 12, fitting 34, or inlet coupling 22, e.g., by threaded connection. The jet 16 is cantilevered from the end nipple 14, intermediate nipple 12, fitting 34, or inlet coupling 22, i.e., the fuel-combustion outlet 18 is supported only by the connection of the jet 16 to the respective end nipple 14, intermediate nipple 12, fitting 34, or inlet coupling 22. Each jet 16 may be straight from the proximate end to the fuel-combustion outlet 18. Specifically, the longitudinal axis of the jet 16 may be straight.

The proximate end of the jet 16 may be threaded, and specifically, includes male threads. The threads at the proximate end may have any suitable size. The threads at the proximate end are the same size as the threads of threaded holes of the end nipples 14, intermediate nipples 12, fittings 34, or inlet coupling 22. For example, the threads of the proximate end may be 1/16-27 NPT threads.

Each jet 16 may be unitary, i.e., a single, continuous piece of material with no seams, joints, fasteners, welds, or adhesives holding it together. Each jet 16 may be formed as a unitary component, for example, by machining from a unitary blank, molding, forging, casting, etc. In the example shown in the Figures, each jet 16 is formed by machining a brass bar, e.g., to include the gas passageway and the other features of the jet 16 described herein.

The jet 16 includes a head at the fuel-combustion outlet 18. The head can be rotated to threadedly engage the threads with the end nipple 14, the intermediate nipple 12, or the fitting 34. The jets 16 may include flats (not shown) that are similar to the flats on the end nipples 14 shown in FIG. 1. The flats can be rotated to threadedly engage the jets 16 with the nipples 12, 14, fittings 34, and inlet coupling 22. The flats may be engaged by a tool to transfer torque from the tool to the jet 16 for engaging the threads with adjacent components.

As set forth above, each jet 16 may include at least one oxygen hole 20 extending through the wall to the bore of the jet 16. For example, the jet includes one oxygen hole 20 when the fuel is natural gas. As another example, the jet includes two oxygen holes 20 when the fuel is propane. In such an example, the two oxygen holes 20 may be spaced diametrically from each other and aligned with each other along the axis of the jet 16.

The oxygen hole 20 may be disposed at any suitable position along the wall. That is, the oxygen hole 20 may be disposed between the proximate end and the fuel-combustion outlet 18. For example, the oxygen hole 20 may be disposed between the proximate end and the head of the barrel. As another example, the oxygen hole 20 may be disposed on the head of the barrel. In such an example, the oxygen hole 20 may extend through one flat of the head.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A burner comprising:
an inlet coupling;
a nipple fluidly connected to the inlet coupling;
a jet supported by and protruding upwardly from the nipple, the jet including an oxygen hole;
the inlet coupling including an inlet hole, an outlet hole fluidly connected to the nipple, and a passageway extending from the inlet hole to the outlet hole;
the passageway of the inlet coupling including a crest between the inlet hole and the outlet hole, the passageway extending upwardly from the inlet hole to the crest and the passageway extends downwardly from the crest to the outlet hole, and the crest being above at least one oxygen hole of the jet.

2. The burner as set forth in claim 1, wherein the nipple is supported by the inlet coupling.

3. The burner as set forth in claim 1, wherein the nipple is directly connected to the outlet hole of the inlet coupling.

4. The burner as set forth in claim 1, wherein:
the nipple is directly connected to the outlet hole of the inlet coupling;
further comprising additional nipples supported by the nipple on the inlet coupling; and
further comprising jets on the additional nipples.

5. The burner as set forth in claim 1, further comprising a second nipple fluidly connected to the inlet coupling and an additional jet supported by and protruding upwardly from the second nipple.

6. The burner as set forth in claim 5, wherein the inlet coupling includes a second outlet hole fluidly connected to the second nipple, the passageway extending downwardly from the crest to the second outlet hole.

7. The burner as set forth in claim 6, wherein the outlet hole and the second outlet hole are coaxial.

8. The burner as set forth in claim 6, wherein:
the inlet coupling is a unitary block;
the passageway, the inlet hole, the outlet hole, and the second outlet hole extend through the unitary block.

9. The burner as set forth in claim 8, wherein the inlet coupling has a cuboid-shaped portion in which the passageway extends.

10. The burner as set forth in claim 6, wherein the nipple is directly connected to the outlet hole of the inlet coupling and the second nipple is directly connected to the second outlet hole of the inlet coupling.

11. The burner as set forth in claim 1, further comprising additional jets supported by and protruding upwardly from the nipple.

12. The burner as set forth in claim 1, wherein the inlet coupling, the nipple, and the jet are brass.

13. The burner as set forth in claim 1, wherein the jet includes a fuel-combustion outlet.

14. The burner as set forth in claim 1, wherein:
the inlet coupling is a unitary block;
the passageway, the inlet hole, and the outlet hole extending through the unitary block.

15. The burner as set forth in claim 14, wherein the inlet coupling has a cuboid-shaped portion in which the passageway extends.

16. A burner comprising:
an inlet coupling;
a first branch of nipples fluidly connected to the inlet coupling;
a second branch of nipples fluidly connected to the inlet coupling;
jets supported by and protruding upwardly from the nipples of the first branch and the second branch, at least one of the jets including an oxygen hole;
the inlet coupling including an inlet hole, a first outlet hole fluidly connected to the first branch of nipples, a second outlet hole fluidly connected to the second branch of nipples, and a passageway extending from the inlet hole to the first outlet hole and the second outlet hole;
the passageway of the inlet coupling including a crest between the inlet hole and the first and second outlet holes, the passageway extending upwardly from the inlet hole to the crest and the passageway extends downwardly from the crest to the first outlet hole and the second outlet hole, and the crest being above at least one oxygen hole of the jets.

17. The burner as set forth in claim 16, wherein the first branch of nipples and the second branch of nipples are supported by the inlet coupling.

18. The burner as set forth in claim 16, wherein:
the inlet coupling is a unitary block;
the passageway, the inlet hole, the first outlet hole, and the second outlet hole extending through the unitary block.

19. The burner as set forth in claim 18, wherein the inlet coupling has a cuboid-shaped portion in which the passageway extends.

20. The burner as set forth in claim 16, wherein the outlet hole and the second outlet hole are coaxial.

21. The burner as set forth in claim 16, wherein the first branch of nipples is directly connected to the first outlet hole of the inlet coupling and the second nipple is directly connected to the second outlet hole of the inlet coupling.

22. The burner as set forth in claim 16, wherein the inlet coupling, the nipples of the first and second branches of nipples, and the jet are brass.

23. The burner as set forth in claim 16, wherein the jets each include a fuel-combustion outlet.
